(19) United States
(12) Patent Application Publication
(10) Pub. No.: US 2008/0140436 A1
(43) Pub. Date: Jun. 12, 2008

(54) METHOD AND SYSTEM FOR A REACHABILITY MANAGEMENT

(76) Inventors: Frank Burkhardt, Berlin (DE); Andreas Grothe, Berlin (DE); Bettina Lehmann, Falkensee (DE)

Correspondence Address: KENYON & KENYON LLP, ONE BROADWAY, NEW YORK, NY, 10004, US

(21) Appl. No.: 11/942,633

(22) Filed: Nov. 19, 2007

(30) Foreign Application Priority Data
Nov. 17, 2006 (DE) 102006054284.3

(51) Int. Cl. G06Q 10/00; G06F 17/40

(52) U.S. Cl. 705/1

(57) ABSTRACT

A user of a management system, with which the user's reachability is managed, is assigned a reachability matrix in the system. This reachability matrix stores, in the form of reachability records, the respective reachability of the user via the communications media available to him in relation to a plurality of possible statuses. When events occur that result in a change of status with respect to the statuses recorded in the user's matrix, a reachability record of the user's matrix is defined as the actual reachability vector for the respective user on the basis of rules stored in the system, which reachability vector contains information for each medium available to the user for communication as to whether the user is at the moment to be reachable via the respective communications medium. For each communications medium affected by the change, the management system may generate control signals.

### FIELD OF THE INVENTION

The present invention relates to a method for managing the reachability of persons or groups of persons for other persons, that is, for managing the reachability of the respective persons or groups of persons given in the use of communicative media. The present invention further may relate to a management system developed for implementing the method embodiments. The present invention further may relate to a role-based reachability management.

### BACKGROUND INFORMATION

In daily business life, appointment management, as well as managing the reachability of persons involved in the business processes for other persons, can be very important. In recent decades, a multitude of new paths of communication have developed that exist in parallel, but that must also be connected with one another. For example, such new paths of communication include mobile telephony, e-mail, and the evermore expansive use of the internet.

The requirements and conditions of appointment management and of reachability management are frequently intertwined. While in earlier times, the management of the reachability of a person was the exclusive domain of one person charged with this task, for example, a secretary, today, at least with respect to managing the reachability of persons via communications media, there are already several, at least partially automated or machine-controlled processes.

An example of such situation involves the telephone answering machine. The telephone answering machine allows a caller to leave a message for a person who cannot be reached at a specific moment with, e.g., the request for a return call. In fact, the respective person on the basis of his own return call possibly may become reachable for the caller by telephone only at a later time. In another example, call forwarding may occur under various conditions as specified by the user. The possibility of variably defining ringtones for incoming calls as a function of the group to which a caller and/or the called party belong(s) may also be regarded as a simple form of reachability management. The equivalent applies furthermore to e-mail filters, for example, which make it possible to file incoming e-mails automatically according to certain definable rules in different incoming mail folders and possibly to sort our undesired spam in the process. Finally, so-called community applications should be mentioned as well, according to which it is possible, for example, for the members of an internet community or internet user group to identify which of the other members of the community using the respective platform is currently also online.

So-called instant messaging systems are a special form of the above-mentioned community applications. These allow for the exchange of information in a virtual space, the so-called chat room, the persons exchanging information respectively receiving information about the current reachability of other persons in the respective chat room. Such an instant messaging system, which allows for wireless access to the virtual chat room via mobile communications terminal devices, is described in DE 602 03 798 T2 for example. This is a messaging system on a client-server basis, the clients being able to send reachability information in the form of reachability attributes to the server as well as receive corresponding information from the server. The server is able to receive, store and mutually compare the reachability information and to send it to the client devices. Quality characteristics are used in the reachability attributes, via which an application may be addressed. According to reference, there are authorization groups of members who are accorded authorizations that allow them to subscribe to the entire reachability record or only to parts of it. The reference essentially appears to concern the collection and the further distribution, bound to specific authorizations, of reachability information.

In German Patent Reference DE 10 2004 038 833 A1, for example, appears to concern the management of the reachability of one user under two different mobile telephone numbers that are associated with only one SIM card.

The aforementioned examples relate to design approaches to reachability within respectively only one communications medium. They concern design approaches in which the underlying systems do not allow for a targeted dynamic control over the reachability of a user. A true reachability management, however, is basically given only if a respective system not only collects information about the reachability of a person and makes this available to other persons according to criteria of whatever kind, but if it moreover specifically influences or organizes the reachability of a person as a function of boundary conditions to be specified, that is, possibly also dynamically adapts the paths via which the relevant person is reachable to the respective conditions.

The background information also describes group-based or role-based information systems or the access to information role-based guiding systems. An example of this is the authorization management involved in computer systems or networks, in which the authorizations of the individual users participating in the system for accessing parts of the system are regulated and administered. A corresponding design approach is described in, for example, German Patent Reference DE 694 273 47 T2.

### SUMMARY OF THE INVENTION

The present application claims priority to German Patent Application No. 102006054284.3, filed in the German Patent Office on Nov. 17, 2006, the subject matter of which is incorporated herein in its entirety.

Embodiments of the present invention involves a comprehensive design approach for reachability management that goes beyond the existing approaches. The relevant design approach is to offer the option of influencing the reachability of a person and to manage the reachability dynamically by using all available communications media. For this purpose, a method and a system for implementing the method are created.

Embodiments of the present invention involve a method and a management system for reachability management using a correspondingly developed electronic management system. In the context of the following description, a person, whose communicative reachability is managed by the method or by using the management system according to the present invention, is called a user of the management system. For this user, the reachability is managed by the method according to the present invention within a specified organizational/social environment which is modeled in the management system according to embodiments of the present invention that is developed for this purpose. The organizational/social environment of the user is chiefly the user's occupational or workplace environment. Of course, an equivalent management is also possible for a person's private environment. If indicated, however, the reachability management of a person may also be managed within one and the same management system both for the person's occupational environment as well as for the private sphere.

According to an embodiment of the present invention, a person to be managed with respect to his communicative reachability, that is, a user of the management system, is assigned a reachability matrix stored in a memory of the management system. In this reachability matrix, the respective reachability of the user via the communications media in principle available to him is stored with respect to a plurality of possible statuses, the relevant statuses describing characteristics of the person of the user or/and given facts of his organizational/social environment that forms the basis of the reachability management. The mutually corresponding statuses and reachabilities are stored in the reachability matrix in the form of reachability records. When events occur that have been communicated to the management system via interfaces developed on the system, which events result in a change of status with respect to the statuses recorded for a respective user in the user's reachability matrix, then in each case a reachability record of his reachability matrix is defined for the respective user as a current reachability vector, which for each medium that is in principle available to the respective user for communication contains information as to whether the respective user is at the moment to be reachable via the respective communications medium. The entry of the respective user into the management system or the start of the management of the user's reachability is in this context also treated as such a status-altering event.

Different possibilities exist for preparing the reachability matrix for a respective user. For example, the reachability matrix may be filled in the course of entering a user into the management system by manual input as a multi-dimensional table. Or, the matrix may be filled by calculating all of the given variants for a user on the basis of the input variables/dimensions to be taken into account and of the basic policies stored in the system. In embodiments, the system should also allow for later modification of the matrix by way of exception, e.g., when basic policies change. Communications media are distinguished on the basis of different approaches to communication, that is, fundamentally different technologies and organizational principles, on the basis of different transmission or switching networks used for transmitting the respective content of communication and/or of different terminal devices used in the utilization of the respective medium of communication. Thus, in the context of the following descriptions for the present invention with respect to the media of communication, distinctions may be made, for example, between fixed network telephony, mobile telephony, IP telephony, the sending of SMS or MMS, e-mailing and the so-called message-to-phone, just to mention a few media of communication at this point. While the telephony variants are so-called synchronous communications media, the other media distinguished above are called asynchronous media. In addition, however, answering machines or voice boxes to be addressed over the fixed telephone network or the mobile telephone network are also regarded as independent and likewise asynchronous media of communication. The individual media of communication are in each case associated with typical terminal devices, the term device in this context being used in a broader meaning and possibly also including a virtual device visualized by software. According to this understanding, a traditional telephone, for example, is a typical terminal device for fixed network telephony, a mobile telephone is a typical terminal device for mobile telephony as well as for receiving and sending SMS or MMS and for listening to a voice mailbox provided by a corresponding provider, an IP telephone is a typical terminal device of IP telephony and an e-mail client is a typical terminal device for e-mailing.

In an embodiment, the reachability vector is defined, according to the present invention, according to criteria formulated in rules and stored in a rule memory of the management system. Examples for this will be provided later. Regarding the interfaces, at this point reference is initially only made to the fact that via these interfaces, by manual input or signals of peripheral electronic components or sensors, data are transmitted to the management system, which concern, for example, changes regarding the presence or absence of the user in a room or a building or changes of the user's appointment calendar.

Embodiments of the present invention may be developed in that in a change of the reachability vector, for each medium of communication affected by the respective change, via which the user is, in principle, reachable, the management system generates control signals, which are output either to a terminal device used by the user of the management system for communicating via the respective medium or to facilities of a communications network used for setting up a communications channel to this terminal device, that is, the access/switching facilities of the communications network. The respective control signals are generated by the management system on the basis of rules that are stored in the already mentioned or in an additional rule memory of the management system. For detecting the respective actual statuses of the corresponding terminal devices or access/switching facilities, the system preferably receives the required information with respect to technically based parameters such as, for example, the reachability via wireless communication, or as to whether a device is switched on or off, or also about person-related parameters that may be controlled in the network or on the device itself such as, for example, diversions to another medium or another number. In the event that a person now attempts to contact the user of the management system via one of the communications media, in principle, available to the user, the desire to make contact is signaled to the respective user of the management system on one or several terminal device(s) determined by the setting of the communications parameters in accordance with the current reachability vector, which is neither necessarily the terminal device of the user actually contacted by the person desiring contact nor a terminal device of the communications medium used by the respective person for making contact. If the user is at the moment not reachable, the person desiring contact receives alternatively or additionally appropriate information. Signaling the desire to make contact on a terminal device of the user may also be achieved in such a way that it is not immediately perceivable for the user. A corresponding situation may be given, for example, in asynchronous media in particular such as, for example, when e-mailing, and may go as far as, for example, blocking an e-mail by spam filters and the user becoming aware of this in the sense of a signaling at most at a later time on the basis of corresponding log files.

The concrete manner of controlling the previously addressed terminal devices or also access/switching facilities and also the corresponding development of the devices and facilities that allows for such a control exists already as various possibilities or approaches for this purpose. In this regard, one should think of, for example, the parlay system (see for example, www.parlay.org), java-capable mobile telephones or USIM applications.

The possibility that the desire to make contact is signaled to the user of the system possibly on a terminal device that is not a typical terminal device of the communications medium used by the person seeking contact for making contact is established with the aid of the previously mentioned control signals generated by the management system. For example, due to a relevant event having occurred, the reachability vector of a user of the management system following the update may identify the user as not reachable for the fixed network communications medium. On the basis of the rules stored in the rule memory, control signals to the effect that a call directed to the fixed network telephone is automatically redirected to the user's mobile telephone are then output, for example, to the corresponding fixed network telephone of the user or to switching facilities of the fixed network operator. Accordingly, the terminal device, on which the desire for contact is signaled (the mobile telephone in the present example) is not the terminal device that was actually contacted by the person desiring contact. If the person desiring contact on his part attempted to make the contact by using a fixed network telephone, then in addition the terminal device on which the desire for contact is signaled is not a terminal device of the communications medium (in this example the fixed network) used for making contact, that is, it is not a typical terminal device of the respective communications medium.

In embodiments, the fact that a person seeking or desiring contact not only receives indications regarding the current reachability of a user of the management system, but rather that the reachability of the user is actively influenced on the basis of events communicated to the system.

In embodiments, the reachability management occurs in addition in a role-based manner. For this purpose, at least one role assigned to the user in the organizational/social environment of the management of the user's reachability enters into the definition of the respectively current reachability vector of the user. This occurs in that this role of the user is stored in a memory of the management system in association with the user's person and in that the corresponding role forms at least within one of the rules stored in the rule memory a criterion for determining the reachability vector. The reachability matrix of the respective user consequently includes at least one reachability record whose associated status is described by, or among other things by, the relevant role. As an example for the mentioned organizational/social environment of a user and of a role assumed by the user within it, the work environment of the user shall be mentioned here, that is, the management of the user's reachability in his occupational environment and the user's concrete position in the company, for example, his activity as a member of the support team. There may be very different requirements regarding the reachability of a member of the support staff than, for example, for the member of a development department. In view of the possibility of occupying several positions in the company, the user of the management system may also be assigned several roles. According to an embodiment of the present invention, additionally multiple roles associated with a user are administered by the management system in accordance with rules stored within it on the basis of priorities. In this case, the current reachability vector of the respective user is determined by taking these priorities into account. With respect to the users of the management system, one development of the present invention also provides for several users to be entered in a role pool and for one or several roles of a user to be transferred to other users of the management systems when specified events occur. According to an embodiment of the role-based reachability management, the role or roles assigned to the user is or are preferably set up to be variable rather than rigid. This means that occurring events are able to influence the role(s) currently occupied by a user. Such roles communicated to the management system via its interfaces may, again in accordance with rules stored in the rule memory of the management system, result in a change or in the discontinuance of roles assigned to the user or even in the assignment of new roles for the user. This makes it possible and, according to a specific embodiment of the present invention, provides for the role pool to be administered in such a way that one or several roles are always assigned to a specified minimum number of persons or users of the management system. As discussed herein, the reachability matrix stored for a user in the system may be variable at least in the exceptional case. From the point of view of a role-based reachability management, such an exceptional case may also occur, for example, if fundamentally new roles are introduced in a company or for its staff, which consequently must also be modeled in the management system.

An embodiment of the present invention provides for persons who are potential candidates for making contact with the user of the management system to be assigned such a role. Thus, such a contact-seeking person may be, for example, the superior of the respective user or a contact person in the purchase department of another company. Here too, it is comprehensible that for these two possibly contact-seeking persons there may be different requirements with regard to the reachability of the respective user.

In an embodiment, the method and system may be role-based both with regard to the role of the user of the management system as well as with regard to the role of persons potentially seeking contact to the user.

The management system according to the present invention is made up of a plurality of mutually interacting electronic, at least in part both hardware-based as well as software-based components and moreover includes memories and various interfaces. According to the present invention, the management system is concretely made up at least of one management component having a reachability management module, one or several rule memories, one communications component, one or several interfaces for transferring presence/absence data and/or location data relating to the users to the reachability management module and one registration component for registering events pertaining to the users. In the reachability management module of the management component, the reachability matrix already mentioned in connection with the method is stored for each user of the management system, and from this reachability matrix the respectively current reachability vector is derived. The reachability vector is updated on the basis of manual data inputs, for example of a user who manually want to influence his reachability, and/or on the basis of output signals of electronic units belonging to the management system. As already explained with respect to the method, the reachability vector is updated according to fixed rules. To this end, the reachability management module interacts with one or several rule memories that also belong to the management component, in which the respective rules to be processed by the reachability management module are stored. The rule memory or rule memories furthermore store(s) rules, according to which, in the event of a change of the reachability vector of a user, control signal are generated for influencing the possible communications channels to the respective user. These control signals are generated by the communications component that is connected for this purpose to the reachability component and are sent out over interfaces belonging to this communications component to terminal devices or access/switching facilities of a communications network. The respective terminal devices or access/switching facilities, of course, must be designed for receiving and analyzing or implementing the relevant signals. Preferably, they confirm the reception and the implementation of these signals to the management system for an actual state detection by a suitable acknowledgement. The system also has interfaces for transferring presence/absence data and/or location data concerning the users to the reachability management module.

According to an embodiment of the management system of the present invention relating to a role-based reachability management, as was already explained with regard to the method, the management component has a role management module in addition to the reachability management module. In the role management module, the roles assigned to users of the management system and/or to persons communicating with the users are administered. For this purpose, the rule memory or rule memories of the system also store rules that form the basis for the administration of the roles by the role management module. To this end, the latter, of course, has access to the respective rule memory or memories. As already explained with reference to the method, this also offers the possibility of designing or assigning the roles dynamically, that is, of modifying, deleting or supplementing the roles assigned to individual persons on the basis of events registered by the system.

According to an embodiment that meets the requirements of actual practice, the management additionally has a user administration or has access to one. In such a user administration, which may be used by other systems, specific boundary conditions concerning the individual users may be administered, which in this case thus do not have to be held within the reachability management module or the role management module itself. These boundary conditions may be, for example, information as to via which communications media a user is in principle reachable or as to which roles the user may generally assume at all, the latter question quite possibly being different from the question as to which roles a user may occupy temporarily. According to one possible specific embodiment of the management system, the latter has at least one interface provided for transferring presence/absence data, which is designed for communicating with RFID chips carried along by users of the system.

### BRIEF DESCRIPTION OF THE DRAWINGS

FIG. 1 shows a block diagram for a embodiment in principle of the management system according to the present invention.

FIG. 2A shows, in exemplary fashion, several reachability vectors possible for a user.

FIG. 2B shows an example for the change of the reachability vectors as shown in FIG. 2A because of an event

FIG. 2C shows a possible extracted reachability vector in relation to the matrix in FIG. 2B.

FIG. 3 shows the visualization of an exemplary three-dimensional reachability matrix, in which several reachability vectors are depicted.

FIG. 4 shows a symbolic representation of possible dependencies between the variables and states determining the reachability of a user.

### DETAILED DESCRIPTION

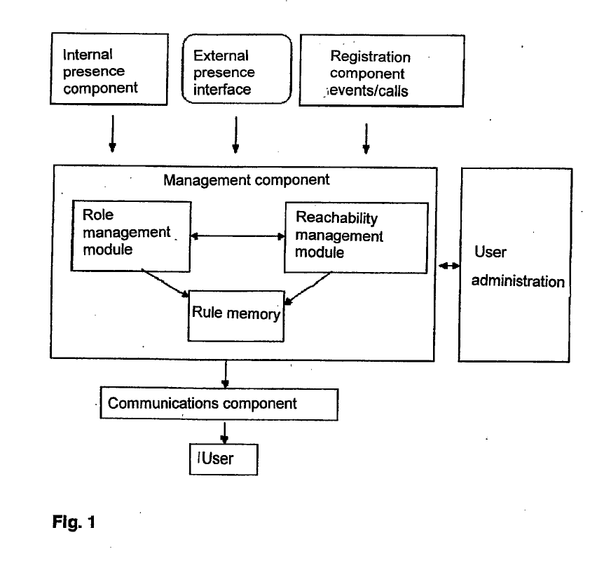

FIG. 1 shows the components of a possible specific embodiment of the management system according to the present invention and their cooperation. The main component of the system is the so-called management component. According to the example shown, this component includes a reachability management module, a role management module and a rule memory, which interact with one another. In the example shown, the management component additionally has access to a general user administration. Furthermore, the system includes several interfaces, a registration component and a communications component, which will be described in more detail below.

First, let it be assumed that for a user of the system, that is, a person whose reachability is to be managed with the aid of the present invention, the reachability management occurs independently of possible roles assigned to the respective person in a company. However, the reachability of the respective person, the user, for others, that is, third parties, is to depend on who the respective third party is. In the following descriptions, these third parties, that is, persons who are potentially seeking contact with the user of the management system, are to be referred to in a simplifying manner as callers, irrespective of which communications medium they use in an individual case to make contact.

For the user, that is, for the person managed with respect to his communicative reachability, a reachability matrix is set up in the reachability management module when the user is first included in the management system, and this reachability matrix is filled out, for example, by manual input as a multi-dimensional table. Because the reachability of the user is to depend on the person of a caller desiring contact with the user, the user's reachability is modeled in the system in the form of a two-dimensional matrix. The potential callers are assigned a role, which is administered in the role management module.

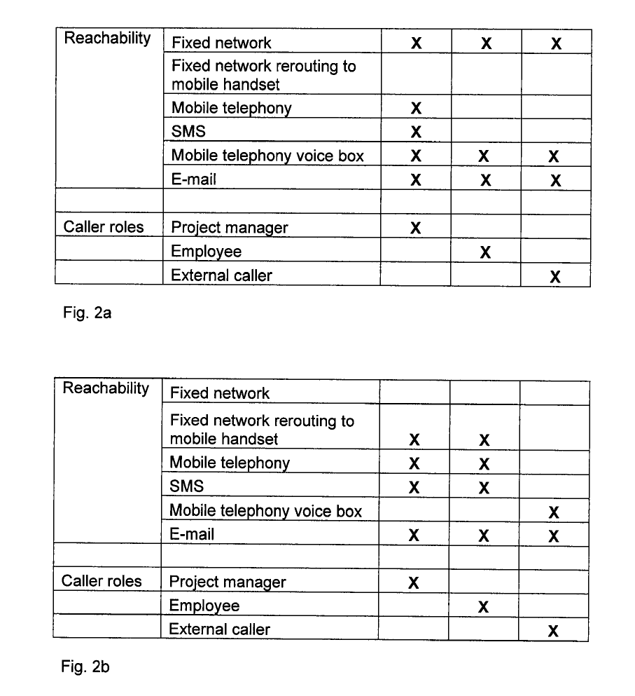

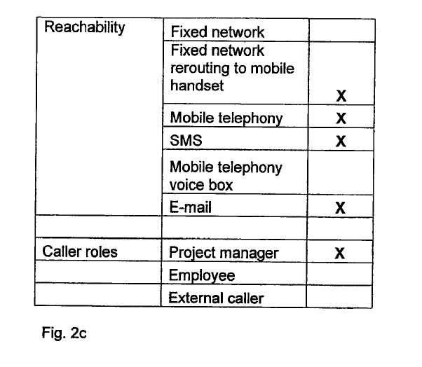

FIG. 2a shows in exemplary fashion several reachability vectors derived for a user from the reachability matrix associated with the user in the management system. As may be seen, different reachability vectors are defined for the user under consideration as a function of the persons (callers) respectively seeking contact with the user. That is to say, the system assign roles to the callers and defines the reachability vectors for the respective user in a role-dependent manner in relation to the callers at least under certain given facts of the user's organizational/social environment that forms the basis of the management. According to the example shown in FIG. 2A, the callers are distinguished according to the roles of employee (employee of the firm of which the user is also an employee), project manager and external caller. In the reachability matrix of the user, as a function of the roles of potential callers, different reachabilities are given for the individual communications media available to the user and recorded as a multiplicity of reachability records, which may be defined as a respective current reachability vector as a function of the status, that is, as a function of characteristics of the person of the user and/or given facts of his organizational/social environment in accordance with the rules stored for this purpose in the management. In this context, in the part of the respective reachability vector pertaining to the considered communications media, a cross symbolizes that the user is reachable via the respective communications medium and that the reachability is implemented via the respective communications medium and the associated terminal device. In the example shown, the user is reachable for the project manager at the considered time via all communications media available to him, no rerouting from the user's fixed network telephone to his mobile telephone being activated because of the reachability via the fixed network, and no calls entering the voice box provided by the relevant mobile telephony provider because of the reachability via the mobile telephone. For other employees of the firm and for external callers, by contrast, the user is reachable only via the fixed network, the voice box or via e-mail, as can be seen from the illustrated reachability vectors. Let it be assumed that the user has a company ID card having an integrated RFID chip. This chip makes it possible to determine if the user leaves the space (his usual workspace or his office). The corresponding presence/absence data are transmitted directly to the reachability management system via the one interface denoted in this context by “internal presence”.

On the basis of the rules stored in the rule memory of the management system, in such a case the user's previously considered reachability vectors as shown in FIG. 2b are modified so that the user, in the event of a call or contact attempt on the part of the project manager, to be sure is not reachable directly via the fixed network or the fixed network telephone, but a call forwarding to the user's mobile telephone is activated in the fixed network telephone. This is done by control signals generated by the management system, more precisely, by its communications component according to fixed rules and sent to the user's fixed network telephone. The control signals activate in the suitably designed fixed network telephone the rerouting of the call to the mobile telephone, the subscriber number of the mobile telephone being transmitted along with the control data. The relevant mobile telephone number is stored in the system, for example, in association with the user in the user administration. In the same case, the reachability vectors for other persons contacting the user are modified, for example, in such a way that other employees of the company may also reach the user via his mobile telephone. To be sure, this reachability via the mobile telephone is ensured only in that the other employees are not able to call the user directly on the mobile telephone, but that a call going to the user's fixed network telephone is rerouted to the mobile telephone. With respect to external callers, in the example shown, a reachability vector is established for the user when leaving his workspace, according to which the user can only be reached via e-mail or the voice box. The changes made to the communications parameters of terminal devices and/or access/switching facilities on the basis of the emitted control signals are confirmed to the management system by a suitable acknowledgement so that in the system there is at any time an absolute transparency and thus a reliability of decision with respect to all actual statuses, that is, both with respect to the data concerning the person of the user or the user's organizational/social environment as well as of the setting of the terminal devices or access/switching facilities.

Changes of a user's reachability vector may also be due to other events or given facts, which are made known to the management component via the “external presence” interface or the registration component. For example, mobile telephony providers (with whom, if necessary, a corresponding contract exists or a corresponding chargeable service has been subscribed) may provide the management component via the “external presence” interface with data regarding the user's current location outside his office. For example, the user's appointment calendar or events such as a telephone conversation with a caller currently already under way are entered into the management via the registration component. FIG. 2C show a possible reachability vector extracted from the matrix in FIG. 2B. These reachability values are signaled to the communications component and represent the current setpoint values for a current reachability status.

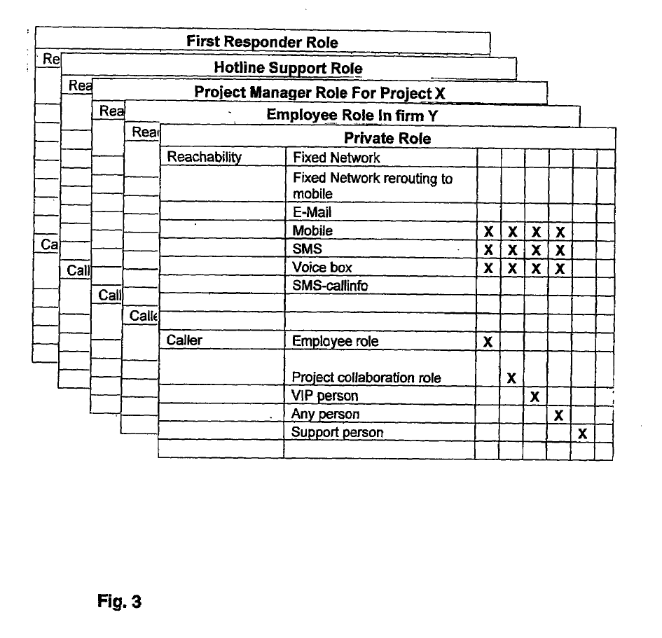

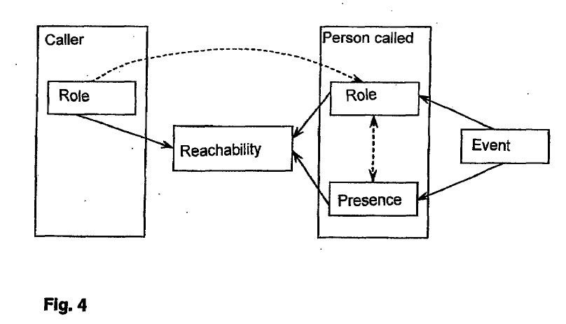

FIG. 3 shows in exemplary fashion a multi-dimensional reachability matrix for a user. In this matrix, in addition to the roles of possible callers, roles assumable by the user of the management system within the firm are also taken into account, amongst which there is also a role denoted as private, which is assigned to the user if he is in the firm, but currently not on duty, that is, if he is on lunch break for example. In accordance with the represented matrix, the reachabilities of the user change, for example, as a function of whether or not the user is currently scheduled for duty in support or as a function of which other roles are possibly assigned to the user in addition to support. Both the roles of possible callers as well as the roles of the user are administered in the role management module. The roles of the user may possibly change as a result of occurring events. Thus it is conceivable that a user scheduled to support loses this role temporarily because he leaves the workspace at his fixed network telephone and that instead the support role is temporarily assigned to another user whose reachability is also managed via the management system of the present invention and for whom there is a record in the user administration that he is in principle able to fulfill the support tasks. The relationships existing between the roles of the user and the roles of potential callers as well as the reachability or the corresponding components of the system managing the latter are shown in FIG. 4 with the inclusion of the rule memory, in which the rules for the management are stored.

Additional examples are presented below without detailed reference to the drawings.

Employee xy, a user of the management system, has assumed the “hotline” role. This entails that all calls coming in from the outside and identified as hotline calls are put through to his workspace telephone.

The departure of employee xy from his workspace is registered by sensor and is signaled to the management component via the “internal presence” interface. Both the role management module as well as the reachability management module receive the signal. The fact that xy is currently active in the “hotline” role is registered in the role management module or in the user administration. Specific conditions with respect to the presence of the occupant of the role, or the user, are tied to the role, however (stored in the rule memory). In the current case, the presence in the workspace is defined as absolutely necessary for performing the “hotline” role. The role management module is implemented in such a way that it is possible to determine and resolve the described contradiction (the presence of the respective employee is required according to the “hotline” role, but he has left his workspace). In the example, the solution is for the system to withdraw the hotline role from employee xy. The role change in turn may have an effect on the employee's reachability, which is now newly formed by the reachability management module. In the present case, this may mean that the system no longer puts hotline calls through to the workspace telephone of the user who has temporarily left his workspace.

The sequence may also unfold as follows, however. The departure of employee xx from his workspace is signaled via the “internal presence” interface. The reachability management module retrieves the rules from the rule memory and determines that a change of the reachability of the employee is required. A new reachability vector is formed, which now activates the feature “relay from the fixed network to the mobile telephone”. The implementation of the new reachability functions as already described by sending out appropriate control signals via the communications component to the network operators or directly to the terminal devices.

As soon as the employee enters the meeting room, which may be determined by sensor using RFID technology for example, the “internal presence” interface in turn signals the change of the presence data of employee xx. The presence in the meeting room results in the application of another rule, according to which the relay from the fixed network telephone to the mobile telephone is now switched off and instead calls to the fixed network telephone now go to the answering machine or/and the mobile telephony voice box. Alternatively, in the case of identified callers who are categorized by the system as belonging to the “VIP” group, a so-called callinfo may be sent as an SMS to the mobile telephone of the employee who is still in the meeting room. The callinfo includes for example the name of the caller and the time of the call attempt.

If a user is able to occupy several roles at the same time, then this presents new requirements which must be resolved by the role management module. Employee “z” of a firm is traveling in his role as project manager of project x. Since he is not in his workspace, the reachability management module initiates a relay of all callers to the mobile telephone of “z”, in accordance with the rule in the rule memory. For example, via an application on his mobile telephone, employee “z” is informed that a first aid case has occurred in one of the neighboring offices. The event in this example is registered by the system via the dialing of the emergency telephone number. Employee “z” is a trained first responder and is registered in the system as suitable for this role. For this reason, the role management module signals the emergency on the mobile telephone via the application and asks employee “z” whether he is able to accept the role of first responder. Employee “z” confirms this and goes into the office of the affected colleague in order to help until the emergency physician arrives. With the confirmation, employee “z” now occupies two roles in parallel, that is, the role of project manager of project x and that of first responder. The two roles entail a conflict regarding the stored rules for reachability. The reachability in the first responder role in this example does not allow calls to be relayed inside the firm from the fixed network telephone to the mobile telephone of employee “z”. The role management module now implements a prioritization of the roles and signals this to the reachability management module which now generates a new reachability vector and subsequently implements the resulting reachability as already described.

As discussed herein, users of the management system according to the present invention may also be administered with respect to their roles in role pools. For this purpose, a number of occupants of the role, e.g. “hotline”, may be defined, which is to be kept constant by the management system, although the presence data of the role occupants may change in such a way that, as already described in the example above, the system must withdraw the role. In order to master this task, the role management module is equipped with additional functionality. The role management module now administers a set of potential role occupants and maps this onto the required number of active role occupants. For this purpose, the potential role occupants are marked with static or dynamic priorities. A simple ranking that is permanently configured in the system may be used as the static priority for the assignment of roles (if there is a hotline, then user xyz is always the first and user xxy the second to be assigned the role). Dynamically changing presence data or presence information (locality, mood, in a meeting or not . . . ) may be used as dynamic priority for example, that is, xyz and xxy are assigned the role only if they are not sitting in a meeting. The role may be withdrawn from a user due to changing presence data. If the role management module in this case withdraws the “hotline” role from one of the assumed four role occupants, then an algorithm is now implemented, according to which, in accordance with the priorities, the next employee is now selected from the set of potential role occupants who is assigned the “hotline” role. With the role assignment, the reachability of this employee possibly changes as well in the manner already described.

1.-12. (canceled)

13. A method for managing the reachability, given by the use of communicative media and associated terminal devices, of at least one person for other persons using an electronic management system designed for this purpose, the user of which is the relevant person whose reachability is to be managed within a predefined organizational/social environment that is modeled in the management system, wherein
a.) the relevant user is assigned a reachability matrix stored in a memory of the management system, in which, with respect to a plurality of possible statuses that describe characteristics of the person of the user or/and given facts of the user's organizational/social environment that form the basis of the reachability management, the reachability of the relevant user via the communications media in principle available to him are stored in the form of reachability records,
b.) when events occur that are communicated to the management system via interfaces developed on the latter, which events alter characteristics of the person of the user or/and given facts of the user's organizational/social environment and thus effect a change from one to another of the statuses recorded for the user in the reachability matrix, a reachability record is defined, according to criteria laid down in rules and stored in a rule memory of the management system, from the reachability matrix for the relevant user as the current reachability vector, the entry of the user into the system for managing the user's reachability also being treated as such a status-altering event,
c.) in the event of a change of the reachability vector of the relevant user, the management system outputs control signals, formed on the basis of rules likewise stored in the rule memory, for each communications medium affected by the respective change, by which either a terminal device used by the relevant user of the management system for communicating over the respective communications medium or access/switching facilities of a communications network used to establish a communications channel to this terminal device are adjusted to the changed reachability by changing the relevant communications parameters,
d.) the desire to make contact via one of the communications media in principle available to the user is signaled to the user of the management system on one or more terminal device(s) determined by the setting of the communications parameters, in accordance with the current reachability vector, which terminal device is neither necessarily the user's terminal device that was actually contacted by the person desiring contact, nor a terminal device of the communications medium used by the relevant person for making contact, or/and the person desiring contact receives information about the fact that the relevant user is at the moment not reachable at all.

14. The method as recited in claim 13, wherein the user's reachability matrix includes at least one reachability record, the associated status of which is described at least by one role assigned to the user in the organizational/social environment of the management of the user's reachability, this role of the user being stored in association with the person of the user in a memory of the management system or in a peripheral unit cooperating with the management system and forming a criterion for defining the reachability vector at least within one of the rules stored in the rule memory.

15. The method as recited in claim 14, wherein several roles assigned to a user are administered by the management system in accordance with rules stored within it on the basis of priorities and the respectively current reachability vector of the relevant user is determined by taking these priorities into account.

16. The method as recited in claim 14, wherein the type and the number of the roles assigned to the user in the management system is variable, at least one event existing, the occurrence of which, communicated to the management system via the interfaces, results in a change, a discontinuance or an addition of a role for the user in accordance with rules defined in the rule memory of the management system.

17. The method as recited in claim 16, wherein several users of the management system are included in a role pool and one or several roles of a user are transferred to other users of the management system when defined events occur.

18. The method as recited in claim 17, wherein the management system is able to administer the role pool in such a way that one or several roles of the role pool are always assigned as an active role to a defined minimum number of users.

19. The method as recited in claim 13, wherein in the definition of the respectively current reachability vector of the user a role is included, which is assigned to a person desiring contact to the user in the organizational/social environment of the management of the reachability of the user, provided that the person desiring contact is known to the management system and the respective person is identifiable by at least one unit of a communications channel used for signaling the desire to make contact, in that the reachability vector defined for the relevant user of the management system is once again updated by applying at least one rule stored in the rule memory, for which the role stored at an earlier time in a memory of the management system in association with the person seeking the contact forms a criterion, a renewed adjustment of the communications parameters affected by the update being performed and the desire to make contact being signaled on a terminal device of the user only afterwards.

20. A management system for managing the reachability, given by the use of communicative media, of at least one person for other persons, having a plurality of mutually interacting electronic, at least partially computer-aided components and having memories and interfaces, wherein this is at least made up of:
a.) a management component having a reachability management module, in which for each user of the management system a reachability matrix describing the user's reachability via different communications media in principle available to the user is stored and, when events communicated to the management system occur, which change characteristics of the person of a user or/and given facts of his organizational/social environment, a current reachability vector is formed from this reachability matrix for the respective person in accordance with defined rules.
b.) a communications component for generating control signals derived on the basis of rules and for sending these out to terminal devices designed to receive them and to evaluate them or to access/switching facilities of a communications network via corresponding interfaces of the communications component,
c.) one or several rule memories belonging to the management component, in which the rules, to be processed by the management component, for forming the reachability vectors the users and for deriving the aforementioned control signals are stored,
d.) one or several interfaces for transferring presence/absence data and/or location data concerning the users to the reachability management module,
e.) one or several interfaces for sending out the control signals generated in the communications component,
f.) a registration component for registering the events concerning the users and for transferring data relating to these events to the reachability management module.

21. The management system as recited in claim 20, wherein the management component in addition to the reachability management module has a role management module for administering roles, which are assigned to users of the management system and/or to persons communicating with them.

22. The management system as recited in claim 21, wherein rules are also stored in its rule memory or rule memories that form the basis for the administration of the roles in the role management module that has access to the rule memory.

23. The management system as recited in claim 20, wherein it has a user administration or access to a user administration used also by other systems.

24. The management system as recited in claim 20, wherein at least one of the interfaces provided for transferring presence/absence data is designed for communicating with RFID chips carried along by users of the system.
